(19) United States
(12) Patent Application Publication
(10) Pub. No.: US 2017/0302793 A1
(43) Pub. Date: Oct. 19, 2017

(54) BLOCKING UNWANTED COMMUNICATIONS FOR A SUBSCRIBER POOL

(71) Applicant: Michael W. Starkweather, Tampa, FL (US)

(72) Inventor: David Stock, Franklin, TN (US)

(21) Appl. No.: 15/098,173

(22) Filed: Apr. 13, 2016

(51) Int. Cl. H04M 3/436; H04W 8/20; H04M 3/42

(52) U.S. Cl. CPC H04M 3/436; H04M 3/42042; H04W 8/20

(57) ABSTRACT

A method and system of blocking unwanted communications (UC) intended to be sent to a first and second communication device (CD) in a pool of CDs. There is in an illustrative embodiment a remote server with computer hardware designed to process communication information to and from the first and second CD to the remote server. Thus, when an UC is received by a first CD, the server is notified of the UC information, than the UC information is shared with all other CDs coupled to the server. Thus, when a single spam caller calls a single CD in the network, all other CDs can be block from that spam UC. Thereafter, automated reports may be periodically sent to all CDs regarding various statistical data on the number blocked and other data.

### PRIORITY REFERENCE TO RELATED APPLICATION

This application claims NO priority benefit under 35 U.S.C. §119(e) from any provisional application.

### STATEMENT REGARDING FEDERALLY SPONSORED R&D

Not applicable.

### PARTIES OF JOINT RESEARCH AGREEMENT

Not applicable.

### REFERENCE TO SEQUENCE LISTING, TABLE, OR COMPUTER PROGRAM LISTING

Not applicable.

### BACKGROUND OF THE INVENTION

### 1. Field of the Invention

The present disclosure is directed to a method, system and apparatus for allowing a user in a pool of users to block unwanted telecommunication for the pool of users, and in particular, the invention is for identifying, collecting, sharing and responding to calls and messages that are unwanted as disclosed in the specification and drawings of the invention and the related claims.

### 2. Description of the Related Art

There are many methods for blocking unwanted, unsolicited, prank or crank communications or calls to cell phone users in the prior art. For example, manual setting a blacklist by a single user is a usual way for blocking the unwanted calls for that user. The user can manually add a phone number from call history, a short message or a contact list or call a phone number directly in a black list directly. The phone numbers listed in the blacklist are usually regarded as unwanted calls. The methods above relies on a personal single subjective judgment and the unwanted phone number is added manually by that single user, which has the advantage of adding the phone number correctly, but has the disadvantage of post processing, consuming personal energy, requiring manual adding, wasting time and energy and can not early block the crank calls which have not been received before.

Currently, millions of unwanted communications by text or phone calls are being placed by hundreds of call centers located in India, Philippines, Panama, and throughout the United States. Additionally, there are thousands of collection agencies placing millions of calls a day. Some phone users have reported to receive over one hundred unwanted phone and text messages by these unwanted individuals in a single day, virtually preventing the user from using their own phone for their own personal business.

Recently, there have been several prior art patents and applications that enables the single user to block unwanted solicitations or telecommunications. The following patents and applications are provided as examples of such known art, and are herein incorporated by reference for their supporting teachings to the disclosed invention, whereby:
1. U.S. Pat. No. 5,467,388, to Red, Jr. et al., issued Nov. 14, 1995, teaches of a method and apparatus for selectively blocking incoming telephone calls.
2. U.S. Pat. No. 5,809,128, to McMullin, issued Sep. 15, 1998, teaches of a Method and apparatus permitting notification and control of blocked incoming calls over a data network.
3. U.S. Pat. No. 6,990,187, to MacNamara et al., issued Jan. 24, 2006, teaches of a method for blocking repeated occurrences of nuisance calls.
4. U.S. Pat. No. 8,150,377, to Patterson et al., issued on Apr. 3, 2012, teaches of a system and method of maintaining communications policy settings in a wireless network.
5. U.S. Pat. No. 8,326,334, to Kim et al., issued Dec. 4, 2012, teaches of an apparatus and method for managing spam numbers in mobile communications terminals.
6. U.S. Pat. No. 8,774,785, to Kirchhoff et al., issued Jul. 8, 2014, teaches of a method and system for blocking unwanted communications.
7. U.S. Pat. No. 8,958,782, to Kirchhoff et al., issued Feb. 17, 2015, teaches of a method and system for blocking unwanted communications.
8. U.S. Pat. No. 8,644,485, to Vendrow et al., issued Feb. 4, 2014, teaches of an intelligent softswitch for managing a call.

None of these prior art patents teaches the disclosed invention either singly or in combination. What is needed in the art is a method, system and apparatus for allowing a user to block unwanted telecommunication, and in particular, an invention for identifying, collecting, sharing and responding to calls and messages that are unwanted as disclosed in the specification and drawings of the illustrated embodiments of the invention and the related appended claims.

### SUMMARY OF THE INVENTION

The present invention has been developed in response to the present state of the art, and in particular, in response to the problems and needs in the art that have not yet been fully solved by currently available nuisance call apparatus and systems. Accordingly, the present invention has been developed to provide a method, apparatus, and system for blocking unwanted communications (UC) intended to be sent to a first and second communication device (CD). There is a remote server with computer hardware designed to process communication information to and from the first and second CD to the remote server. When an UC is received by a first CD, the server is notified of the UC information, and that UC information is shared with all other CDs coupled to the server. Thus, when a single spam caller calls a single CD in the network, all other CDs will block that spam UC. Thereafter, reports are periodically sent to all CDs regarding various statistical data on the number blocked and other data.

There is also described a method of blocking unwanted communications (UC) intended to be sent to a first and second communication device (CD), the method comprising: maintaining, in a remote server, computer hardware designed to process communication information to and from the first and second CD to the remote server; receiving, at the first CD, a first UC; performing, at the first CD, notification steps that notify the remote server that an UC has been identified and data about the UC; receiving, by the remote server, information that an UC has been received by the first CD; notifying, by the remote server, the second CD about the UC received by the first CD; enabling the second CD to block the UC from contacting the second CD; and generating, by the remote server and sent to the first and second CD, a report about data related to the UC.

Additionally, there is described one embodiment for a method wherein the report is selected from the group consisting of showing: 1) how many calls were blocked for a CD by hour, or by day, or by month; 2) location where the UC is from; 3) number of new UC being identified by an individual CD; 4) how many times the CD identified UCs were used by all other CDs; 5) how many times a particular UC was blocked for a particular CD; or 6) number of times over a time period when calls are being blocked. Also, there describes an embodiment wherein the report is selected from the group consisting of: a bar chart, a pie charts, animations, a scatter diagrams, or a time line.

The unwanted communication method also describes in one embodiment wherein the performing step further comprises requiring the first CD to identify if the UC is a personal UC or a commercial UC. Wherein, if the UC is a personal UC, the server will not perform the notifying step that would notify the second CD, since the personal UC does not involve the second CD.

Additionally, the unwanted communication method has the communication device selected from the group comprising of: a desktop computer, a laptop computer, a tablet computer, a digital communication watch, a cell phone, or a land-line phone.

In another embodiment of the invention, the unwanted communication method has the server will not notify the second CD until at least one other CD has also identified the UC to be blocked.

In one embodiment, the remote server includes: a memory that stores call data involving the first and second CD, a processor for performing the server operation, send receive module to facilitate communication to the first and second CD, and a response module to generate reports to send to the first and second CD.

Another embodiment is that the unwanted communication method has the unwanted communication selected from the group of: text messages, videos, pictures, or audio communications.

Reference throughout this specification to features, advantages, or similar language does not imply that all of the features advantages that may be realized with the present invention should be or are in any single embodiment or the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

### BRIEF DESCRIPTION OF THE DRAWINGS

In order for the advantages of the invention to be readily understood, a more particular description of the invention briefly described above will be rendered by reference to specific embodiments that are illustrated in the appended drawings. It is to be understood that these drawings depict only typical embodiments of the invention and are not therefore to be considered to be limiting of its scope, the invention will be described and explained with additional specificity and detail through the use of the accompanying drawings.

FIG. 1, illustrates one embodiment of background art wireless communication system in accordance with one embodiment of the invention.

FIG. 2, illustrates one exemplary embodiment of a background art cell-phone.

FIG. 3 illustrates one illustrative embodiment of a background art block diagram of certain internal components known to be within the exemplary cell-phone.

FIG. 4, illustrates one embodiment of a background art method for processing communications in a network.

FIG. 5 illustrates a diagrammatic view of an illustrative system with logic flow and hardware of a call blocking system.

FIG. 6 illustrates one embodiment of a potential report provided to subscribers of the call blocking service.

### DETAILED DESCRIPTION OF THE ILLUSTRATED EMBODIMENTS

For the purposes of promoting an understanding of the principles of the invention, reference will now be made to the exemplary embodiment. Wherein, each statement of an embodiment is to be considered independent or any other embodiment, despite any use of similar or identical language.

Reference throughout this specification to “one embodiment,” “an embodiment,” or similar language that means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed. Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

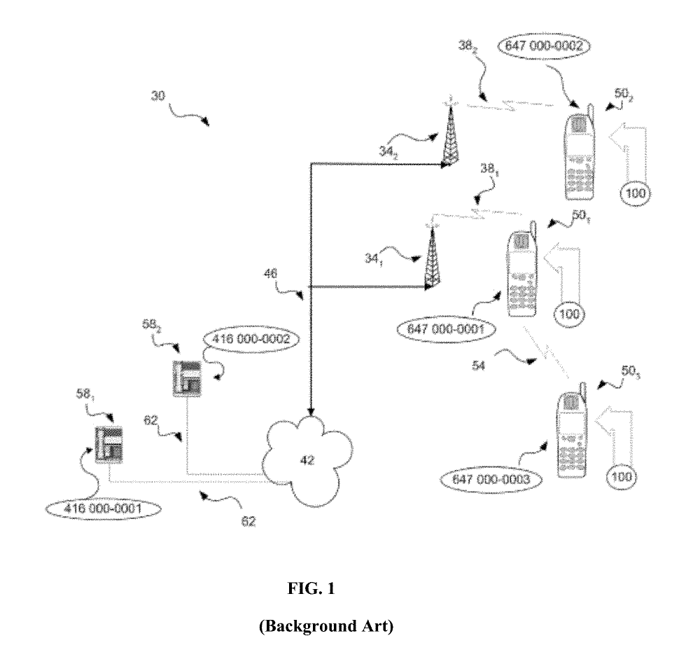

The following prior art figures are illustrative of what can be used for the operation of the present invention, and is herein incorporated by reference into the present application. Referring now to FIG. 1, there is one embodiment of a background art wireless communication system in accordance with the invention is indicated generally at 30. System 30 comprises a plurality of base stations 34 operable to wirelessly transmit across a variety of geographic ranges. Base stations 34 communicate wirelessly over a plurality of links 38. In a present embodiment, links 38 are based on a known voice-based wireless telecommunication such as Global System for Mobile Communications (“GSM”) or Advanced Mobile Phone System (“AMPS”).

In system 30, base stations 34 are also connected to a network 42 through a connection 46. In this embodiment, network 42 is the public switched telephone network (“PSTN”) but, in other embodiments, other types of networks can be employed. Moreover, in this embodiment connection 46 is a fiber-optic wire connection, but in other embodiments connection 46 can be other types of connections such as copper wires or a satellite connection.

System 30 also includes a plurality of subscriber devices, which in this embodiment, each subscriber device is a cell-phone 50 such as those manufactured by Nokia of Keilalandentie 2-4, Finland and Motorola Inc, of Schaumburg, Ill./, U.S.A., but in other embodiments it could have a cell phone and other enhanced functions such as those manufactured by Research In Motion Limited of Waterloo, Ontario, Canada, Apple iPhone out of San Jose, Calif., or by PalmOne, Inc. of Milpitas, Calif. USA. Cell-phones 50 are operable to connect to network 42 via a base station 34's link 38 each time cell-phone 50 is located within a range respective to that access station 34. For example, whenever cell-phone 50 is located within the range of base station 34₁, cell-phone 50 can connect to network 42 by linking with base station 34₁ through link 38₁, and whenever cell-phone 50 is located within the range of base station 34₂, cell-phone 50 can connect to network 42 by linking with station 34₂ through link 38₂. Cell-phones 50 can also communicate with each other directly, without the need for a base station, through a peer-to-peer link 54. In this embodiment, a peer-to-peer link consists of a peer-to-peer IEEE 801.11b/g connection employing voice over IP protocol, but in other embodiments other types of peer-to-peer connections such as infrared and cross-linked wired Ethernet connections could also be used. These and other types of peer-to-peer connections are within the scope of the invention.

System 30 also includes phones 58 connected to network 42 through connections 62. Phone 58 is operable to place and receive phone calls through network 42. In other embodiments, phones 58 could represent multiple phones being operated as a call center from which calls are being placed.

Each call originated by a device typically carries an originator identifier “(OID”), regardless of whether the call is placed through network 42, a base station 34, or through link 54 in a peer-to-peer mode. In this embodiment, an OID is the phone number assigned to each originator phone 58 or cell-phone 50. However, other types of identifiers such as the name under which a phone 58 is registered or a serial number assigned to a cell-phone by the manufacturer can also be used as OIDs, and such variations are within the scope of this invention.

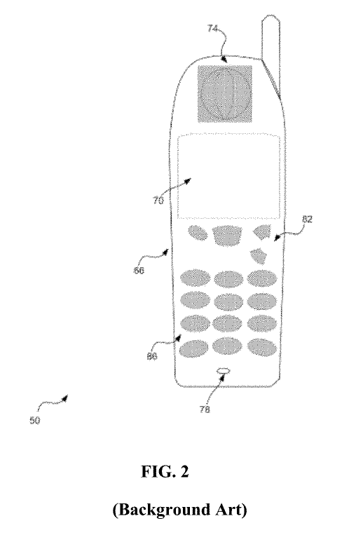

Referring now to FIG. 2, there is one exemplary embodiment of a background art cell-phone 50 shown in greater detail. Cell-phone 50 is based on a computing environment with wireless voice telephony capabilities. (However, it is to be understood that cell-phone 50 can be based on the construction and functionality of any mobile electronic device that can be connected to a wireless network as well, such as an Apple iPhone 5 and such. Such devices include personal digital assistants or laptops computers connected to wireless networks. In a present embodiment, a cell-phone 50 includes, a housing 66, which frames a display 70, a speaker 74, a microphone 78, scroll buttons 82, and a keyboard 86. It will be understood that housing 66, can be made from any suitable material as will occur to those of skill in the art.)

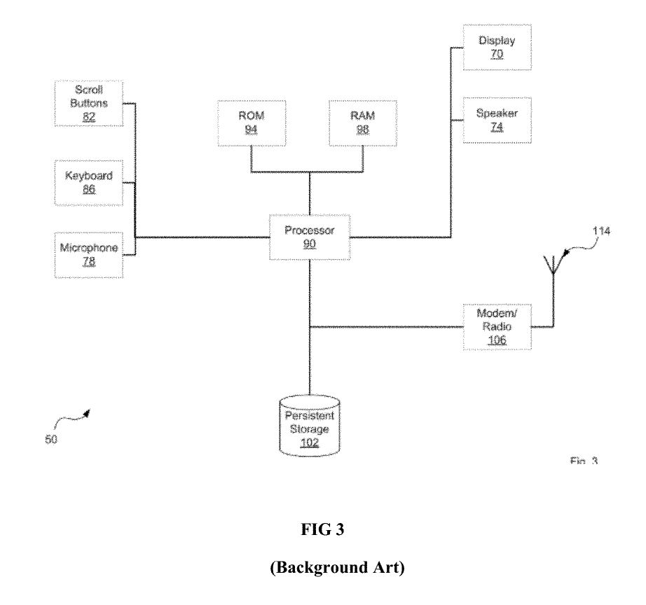

Referring now to FIG. 3, there is one illustrative embodiment of a background art block diagram of certain internal components known to be within the exemplary cell-phone 50 is shown. Cell-phone 50 is based on a microcomputer that includes a processor 90. Processor 90 is connected to a read-only-memory (“ROM”) 94, which contains a plurality of applications executable by processor 90 that enables cell-phone 50 to perform certain functions. Processor 90 is also connected to a random access memory unit (“RAM”) 98 and a persistent storage device 102 that is responsible for various non-volatile storage functions of cell-phone 50. Processor 90 can send output signals to various output devices including display 70 and speaker 74. Processor 90 can also receive input from various input devices including microphone 78 and keyboard 86. Processor 90 is also connected to a modem and radio 106. Modem and radio 106 are operable to connect cell-phone 50 to wireless base stations 34 in range of cell-phone 50, in the usual manner, via an antenna 114.

Referring back to FIG. 1, each cell-phone 50 maintains a common policy (“CP”) database 100, used for determining which received calls should be accepted. CP database 100 is the same for all cell-phones 50. Table I shows an example CP database 100 for cell-phones 50 right before an attempt is made, by phone 58₁, to place a call.

TABLE 1
Example CP Database
100
Field 1
OID
416 000-0002
647 000-0002

Describing Table I in greater detail, Field 1 contains the unique OM associated with a phone or a cell-phone. In this embodiment, as mentioned above, the OID is the phone number associated with a phone or a cell-phone used by the user. It is impermissible for cell-phones 50 to receive calls from phones or cell-phones listed in this table. For example, in this case, it is impermissible for cell-phones 50 to accept calls placed by phone 58₂ (which has an OLD of 416 000-0002), or by cell-phone 50₂ (which has an OID of 647 000-0002).

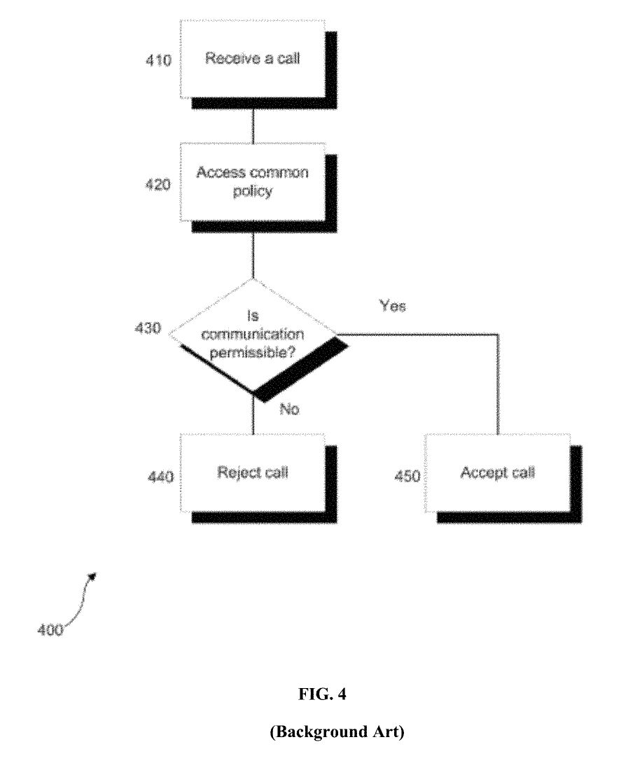

Referring to FIG. 4, there is one embodiment of a background art method for processing communications in a network having CP database 100 is indicated generally at 400. In order to assist in the explanation of the method, it will be assumed that method 400 is operated using system 30, and that, as shown in FIG. 1, cell-phone 50₁ is located within range of station 34 cell-phone 50₂ is located within in range of station 34₂ and cell-phone 50₃ is located within peer-to-peer range of cell-phone 50₁. Furthermore, the following discussion of method 400 will lead to further understanding of system 30 and its various components. (However, it is to be understood that system 30 and/or method 400 can be varied, and need not work exactly as discussed herein in conjunction with each other, and that such variations are within the scope of the present invention).

The current performance of method 400 is initiated by a call placed by phone 58₁. Referring back to FIG. 4, at step 410 a call is received. Step 410 can be performed, for example, by phone 58₁ dialing the phone number for cell-phone 50₁. Accordingly, an attempt is made, in the usual manner, to create a connection with cell-phone 50₁ through PSTN network 42, and, with the aid of station 34₁, through link 38₁. In the present embodiment, the phone number of phone 58₁, 416 000-0001, is forwarded to cell-phone 50₁ as part of the attempt to establish a connection. In other embodiments, other identifiers that uniquely identify the originator of a call in a phone network, such as the name under which a phone is registered, can also be used, and are within the scope of the invention.

Continuing with the example, at step 420 the common communication policy is accessed. In this example, accessing CP database 100 maintained on cell-phone 50₁ itself, as described above, performs step 420. Method 400 then advances from step 420 to step 430, at which point a determination is made as to whether the received communication is permissible. In this example, CP database 100 is examined to determine whether calls from phone 58₁ are permitted. To perform this step, CP database 100 is accessed to determine whether the phone number of phone 58₁, the originator phone, is present in CP database 100. In this case, the phone number 416 000-0001 is not present in CP database 100 meaning that accepting a phone call from phone 58₁ is permissible. Accordingly, step 450 is performed next, and the call is accepted in the usual manner. For example, cell-phone 50₁'s ringer can be sounded if cell-phone 50 on, or the call can be directed to a voice mail if cell-phone 50₁ is off. These and other known manners of accepting a call are within the scope of the invention.

To further illustrate a rejected call under method 400, it is assumed that method 400 is performed by system 30 a second time, but in this second performance, the phone call initiating the performance of method 400 originates from phone 58₂. Accordingly, at step 410 the phone number 416 000-0002, which is associated with phone 58₂, is transmitted to cell-phone 50₁ as part of the attempt to establish a connection with cell-phone 50₁. At step 410, CP database 100 is accessed in substantially the same manner as the first performance of method 400. However, during the second performance of step 430, accessing CP database 100 reveals that phone number 416 000-0002 is present in CP database 100. Accordingly, step 440 is performed next, rejecting the call placed by phone 58₂. Step 440 can be performed in a variety of known ways. For example, the connection can be dropped, a disconnected number message can be played, or the call can be directed to a voice mail informing the originator that calls placed by them cannot be accepted. These and other known manners of rejecting a call are all within the scope of the invention.

In another embodiment, method 400 can be performed when the call originates from the same network that the receiving cell-phone 50₁ is located on, which is in contrast to the first two example performances of method 400 where the call originated on a different network. To illustrate this embodiment, an example is used where the originator is another cell-phone, cell-phone 50₂ in FIG. 1. Accordingly, when cell-phone 50₂ attempts to place a call to cell-phone 50₁, method 400 is performed in substantially the same manner as the last two example performances. Specifically, the performance of the first two steps leads to the reception of cell-phone 50₂'s phone number, 647 000-0002, by cell-phone 50₁, and the accessing of CP database 100. When step 430 is performed, a search of CP database 100 reveals that 647 000-0002 is contained within CP database 100 leading to the performance of step 440, namely the rejection of the call.

Although in the previous embodiments the voice call is received from a PSTN and a cellular phone network, in other embodiments, method 400 can also be performed using other types of connections, such as peer-to-peer links; all these embodiments are within the scope of the invention. For example, method 400 can be performed when a voice communication is attempted between two cell-phones through a peer-to-peer link. To illustrate this embodiment, consider the example shown in FIG. 1 where cell-phone 50 attempts to establish voice communications with 50₁ through a peer-to-peer link 54. Accordingly, at step 410, as in the previous three example performances of method 400, the phone number associated with cell-phone 50₃ (647 000-0003), is transmitted to cell-phone 50₁ as part of an attempt to establish a connection with phone 50₁. After CP database 100 is accessed at step 420, and examined at step 430, it is found that 647 000-0003 is not in database 100, and hence, determined that receiving the voice communication from cell-phone 50₃ is permissible. Thus, method 400 advances to step 450 and the voice communication is accepted by cell-phone 50₃ in the usual manner.

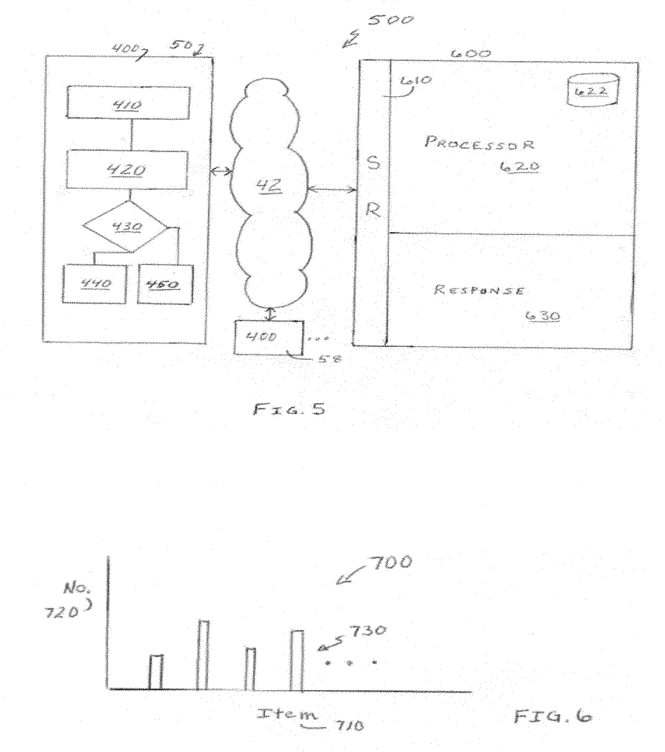

In reference to FIG. 5, there is illustrated a diagrammatic view of an illustrative embodiment of a call blocking computer system 500 invention. In addition to the illustrated elements that are already described in the previous illustrations, in particular, there is a computer system 600, illustrating basic components of a send and receive (SR) module 610, a processor 620, a database 622, and a response module 630 for calculating what response to supply for callers 50, 58 and other calculations.

Generally, in operation, for a number that has already been identified to be blocked by another user of the service, a caller 50 receives a call xyz that logic block 420 shows is a previously requested blocked call, thereby that blocked call xyz is sent over the telephone system 42 to be received by the send receive module 610 of the call blocking server 600, where call xyz is logged in storage device 622, which will record data items about the call xyz. Data items may include, by way of example only: the time of the call, the day, the month, the calling number, the name of the caller, how many others in the service have also received this call, how many times this number has been previously blocked by others, the location of the call origination, etc.

Similarly, for a number that has never been recorded as needing to be blocked, a non-blocked call jkl comes to caller 50, and in logic block 440, the user 50 self identifies the call to be blocked in the future, and that caller jkl information is sent (via the same process as the call xyz) to the database storage device 622. These same two sequences are done for hundreds of subscribers to the service. Whereby, all subscribers to the call blocking service, illustrated by phones 50 and 58, will be updated with the identified phone numbers to block for future calls, so that logic block 420 will block the number when it calls that particular phone 50, 58. In particular, all phones are updated with blocked numbers by having the received identified number to be blocked stored in storage device 622, the processor will send that information to the send and receive module 610, which will send the updated information to all relevant subscribers, so that logic block 420 will know to block that identified number to be blocked. An alternative potential method of disseminating the numbers can be found at US Patent app. 2013/0109356, pub. May 2, 2013, which has already been incorporated by reference.

The main advantage of the illustrated invention is that all identified calls to be blocked by a first caller are then shared with all other subscribers to the service 600. In particular, a spam caller using phone no. xyz will ideally be identified to be blocked by phone user 50 who initially receives the call. Thus, when a spam caller using phone no. xyz next calls phone user 58, logic block 420 will now identify that number as a blocked number and will block the call, despite the fact that the second user 58 has never received that call before or individually selected that particular number to be blocked. Therefore, in other words, all subscribers will benefit from this system 500. The system 600 provides that it only takes a single user to identify a particular phone number as being a spam caller, and then all users of that service benefit from the identification of that spam call.

Modifications to this above system 500 may include the added feature of immediately blocking all calls that do not show the phone number on the caller receivers phone. Similarly, the system 500 may include the immediate blocking of calls that pause for several seconds before the pre-recorded call starts, or when a “blurb” sound occurs.

Another modification to the above system may be that the phone user 50 for different blocked calls can program a different response. These different responses can be provided by response module 630, or stored on the individual's phone 50 in persistent storage 102 or ROM 94. For example, the following are possible automated messages to be used:
1. THE NUMBER YOU ARE CALLING HAS BLOCKED YOUR CALL
2. THE PHONE NUMBER YOU ARE TRYING TO REACH IS NO LONGER IN OPERATION, GOODBYE
3. THE NUMBER YOU ARE CALLING IS NO LONGER IN SERVICE
4. THE PERSON YOU ARE CALLING HAS UNFORTUNATELY PASSED AWAY
5. THE NUMBER YOU ARE CALLING DOES NOT WANT TO TALK TO YOU
6. THE NUMBER YOU ARE CALLING DOES NOT TAKE PHONE SOLICITATIONS
7. THE NUMBER YOU ARE CALLING IS ON THE FEDERAL LIST FOR DO NOT CALL, ANY FURTHER CONTACT BY YOUR COMPANY WILL BE RECORDED FOR PROSECUTION FOR VIOLATION OF THE FEDERAL DO NOT CALL LIST

A further potential embodiment of the illustrated invention may be to provide at least two levels of blocked calls. Specifically, in one embodiment, there is a standard blocking feature for all common telemarketing, spam, unlisted, and sales calls that are intended to call hundreds of phone users. Whereas, a second, less used, call blocking list is of a more personal nature, referred to as a personal unwanted communication (UC). In these personal blocked calls, they are for specific personal callers, like: a former spouse, a former partner, or a former business associate. By requiring the user 50 during logic block 440 to select which type of caller is to be blocked, (a commercial or personal unwanted call) there will not be blocking of personal relationships to all other users in the service that my have beneficial relations with that particular person. Thus, in one embodiment in operation, a user is prompted at logic block 430 to select if the call is to be blocked by enacting logic block 440, the user is further prompted in logic block 440 to identify if this call is a personal caller, like an ex-partner to block, or a spam large scale caller, or commercial caller, that needs to be blocked. That block selection information is then sent via cloud 42, to send to the server 600, and specifically to the send receive module 610, then send to processor 620 then saved in storage 622. Thereby, when the identified block call is personal in nature, it will not be shared over the entire number of users 58, since it is not a large scale spam caller. However, and similarly, because the identified blocked call is identified as a large scale spam caller, then that phone number will be shared with all other subscribers to the service 500, so that when user 58 received a call from the identified blocked number, it will be blocked and not ring on the phone 58.

In further detail, the computer system 600 (also referred to herein as a call blocking server or server) can be taught in more particularity by reference to U.S. Pat. No. 8,644,485, to Vendrow et al., issued Feb. 4, 2014, which generally teaches of an intelligent softswitch for managing a call. In particular, reference is made to FIG. 4 of the '485 patent, which show a block diagram of two potential computer systems that can be used to implement processes and methods described in relation to the present invention, and is herein incorporated by reference for that related teaching.

Referring now to FIG. 6, there is an exemplary data display 700 invention in the form of a well-known chart with x and y axis that may be illustrated on a users phone 50. However, a skilled artisan will know that most any type of data display may be used herein, like pie charts, scatter charts, animations, etc. Specifically, in this embodiment, there is illustrated showing the number 720 of items 710 by way of bars 730. Generally, the present invention contemplates providing a user phone 50 with statistical data 700 or feedback regarding the services provided. Whereby, every time a call is blocked, that action is recorded and saved in database 622, as previously described. Thus, on a regular basis, like instantly, hourly, daily, weekly, monthly, and yearly, a report is automatically generated, or by request of the user, by the response module 630, that will send, via Send Receive module 610, for example, a bar graph 700 to a user phone 50. In this fashion, the user will know how effective the service is working, and see how many blocked calls there are to all users in the service, and other information. Specifically, some of the potential statistical items 710 that may be collected and provided to users 50 are: 1) how many calls were blocked for the individual user by hour, or by day, etc.; 2) show the states where the blocked callers are from; 3) show the countries of blocked callers; 4) show the number of new phone numbers being identified to be listed as blocked to subscribers to the service; 5) show how many the particular user has listed to be blocked by date, or in comparison to others; 6) show how many of the users identified blocked numbers were used by other users of the service; 7) show how many times a particular number was blocked (i.e. an ex-partner); or 8) show the type of call that was blocked, like personal, commercial, or spam; 9) show the exact times over a time period when calls are being blocked for an individual CD or the whole population of CDs using the service, like 20% were blocked before noon, 50% before 4 pm and after noon, and 30% before 7 pm and after 4 pm, or the same information by days of the week, showing 10% on Monday, 12% on Tuesday, etc., then you can show the same data by week of the month or year, or by month of the year to see spikes during pre Christmas sales pushes.

Discussion

It is noted that the illustrated invention is much better than typical prior art in retaining interest in the services provided in blocking undesirable phone calls. Specifically, a skilled artisan of the art of call blocking will realize after a review of the illustrated embodiments, every time a call is blocked, there is a recording of data from that action, and there is a response module that calculates the type of response a particular user would like to see, or what type of report the service provider would like to send to subscribers of the call blocking service.

It is noted that there is illustrated only a single type of statistical report, like a bar chart, wherein a skilled artisan of statistical reporting and charting will easily understand that there are many types of charts, graphs, illustrations, or reports that could be assembled and presented to the customers of the call blocking services. Specifically, there could be pie charts, animations, scatter diagrams, time line, etc., all of which are herein incorporated by reference for the disclosed embodiments provided herein.

Moreover, it is noted that there is illustrated only a single embodiment of implementing a call blocking system. Wherein, a skilled telephone software programmer will realize that there are many ways of implementing the general embodiments of the disclosed invention. Specifically, a phone application, like those implemented on the Apple iPhone (i.e. angry birds, iHart Radio, and skype), could be purchased by a user to subscribe to the call blocking services as described herein.

Additionally, the present embodiments teach that all it takes is a single user to report a phone number to be blocked before that number is sent to all other subscribers of the service. However, it is contemplated to have certain other guidelines to limit legal liabilities for mistaken reports. Specifically, it is contemplated to have multiple separate users identify the same phone number to be blocked, for example, two, three, four, etc. reports. In this fashion, there is absolute certainty that the number is indeed a spam caller. However, in this modified method, each of the first identifiers, would have their individual phones block that same number for their phones, despite that other users still do not have that particular number blocked until reaching the designated number of confirmed identified blocking requests. Of course, it is the storage device 622 that would be storing that information and determining with the pre-designated number of reports have been received before sending out the blocked call number to all other subscribers.

In addition, the present invention has taught the blocking of phone calls, wherein a skilled telephone engineer will understand after reading the currently disclosed embodiments that the current teachings may just as easily be used to block text messages, videos, pictures, or any other type of communication that is exchanged over the currently used phone communications devices. Therefore, any reference to phone number blocking in the illustrated embodiments provided herein should also be considered to include these other forms of digital communications, which can be referred to as unwanted communications (UC).

It has been taught in the disclosed embodiments that the invention solely involves currently known telephones or cell phones. Wherein, a skilled artisan will realize that most any digital device that is used for communication can benefit from the presently disclosed embodiments. Specifically, any computer implemented device that is used to communicate will benefit therefrom, like a desk top computer, laptop, tablet, digital communication watch, etc. Therefore, any reference in this disclosure to a phone, or phone number, should be considered to include any other communication capable device and individual identification number for a specific device being used, which could be referred to as communication devices (CD).

Further, while the present invention has been fully described above with particularity and detail in connection with what is presently deemed to be the most practical and preferred embodiment of the invention, it will be apparent to those of ordinary skill in the art that numerous modifications, including, but not limited to, variation in size, materials, shape, form, function and manner of operation, assembly and use may be made, without departing from the principles and concepts of the invention as set forth in the claims.

What is desired to be claimed as Letters Patent under the United States Constitution, Article 1, section 8, clause 8,“To promote the progress of the science and useful arts, by securing for limited times to authors and inventors the exclusive right to their respective writings and discoveries”, is set forth herein after:

1. A method of blocking unwanted communications (UC) intended to be sent to a first and second communication device (CD), the method comprising:
a) maintaining, in a remote server, computer hardware designed to process communication information to and from the first and second CD to the remote server;
b) receiving, at the first CD, a first UC;
c) performing, at the first CD, notification steps that notify the remote server that an UC has been identified and data about the UC;
d) receiving, by the remote server, information that an UC has been received by the first CD;
e) notifying, by the remote server, the second CD about the UC received by the first CD;
f) enabling the second CD to block the UC from contacting the second CD as a result of the first CD notifying the remote server; and
g) generating, by the remote server and sent to the first and second CD, a report about data related to the UC.

2. The unwanted communication method of claim 1, wherein the report is selected from the group consisting of showing: 1) how many calls were blocked for a CD by hour, or by day, or by month; 2) location where the UC is from; 3) number of new UC being identified by an individual CD; 4) how many times the CD identified UCs were used by all other CDs connected to the remote server; 5) how many times a particular UC was blocked for a particular CD; 6) the number of personal or commercial UCs were blocked, or 7) number of times over a time period when calls are being blocked.

3. The unwanted communication method of claim 2, wherein the report is selected from the group consisting of: a bar chart, a pie charts, animations, a scatter diagrams, or a time line.

4. The unwanted communication method of claim 1, wherein the performing step further comprises requiring the first CD to identify if the UC is a personal UC or a commercial UC.

5. The unwanted communication method of claim 4, wherein if the UC is a personal UC, the server will not perform the notifying step that would notify the second CD, since the personal UC does not involve the second CD.

6. The unwanted communication method of claim 1, wherein the communication device is selected from the group comprising of: a desktop computer, a laptop computer, a tablet computer, a digital communication watch, a cell phone, or a land-line phone.

7. The unwanted communication method of claim 1, wherein the server will not notify the second CD until at least one other CD has also identified the UC to be blocked.

8. The unwanted communication method of claim 1, wherein the remote server includes: a memory that stores call data involving the first and second CD, a processor for performing the server operation, send receive module to facilitate communication to the first and second CD, and a response module to generate reports to send to the first and second CD.

9. The unwanted communication method of claim 1, wherein the unwanted communication is selected from the group of: text messages, videos, pictures, or audio communications.

10. The unwanted communication method of claim 1, wherein the step of notifying, by the remote server, the second CD about the UC received by the first CD is performed only after at least one other CD has received the same UC and reported such to the remote server.

11. The unwanted communication method of claim 1, wherein during a period of time when the other CD has not yet received the same UC and reported such to the remote server, the first CD will still have the UC blocked.

12. A non-transitory computer-readable medium storing a plurality of programming instructions for blocking unwanted communications (UC) intended to be sent to a first and second communication device (CD), comprising:
a) maintaining, in a remote server, programming instructions implemented to process communication information to and from the first and second CD to the remote server;
b) programming instructions for receiving, at the first CD, a first UC;
c) programming instructions implemented to perform, at the first CD, notification steps that notify the remote server that an UC has been identified and data about the UC;
d) programming instructions implemented to receive, by the remote server, information that an UC has been received by the first CD;
e) programming instructions implemented to notify, by the remote server, the second CD about the UC received by the first CD;
f) programming instructions implemented to enable the second CD to block the UC from contacting the second CD; and
g) programming instructions implemented to generate, by the remote server and sent to the first and second CD, a report about data related to the UC.

13. The non-transitory computer-readable medium of claim 12, wherein the report is selected from the group consisting of showing: 1) how many calls were blocked for a CD by hour, or by day, or by month; 2) location where the UC is from; 3) number of new UC being identified by an individual CD; 4) how many times the CD identified UCs were used by all other CDs; 5) how many times a particular UC was blocked for a particular CD; or 6) number of times over a time period when calls are being blocked.

14. The non-transitory computer-readable medium of claim 13, wherein the report is selected from the group consisting of: a bar chart, a pie charts, animations, a scatter diagrams, or a time line.

15. The non-transitory computer-readable medium of claim 12, wherein the programming instructions implemented to perform further comprises programming instructions requiring the first CD to identify if the UC is a personal UC or a commercial UC.

16. The non-transitory computer-readable medium of claim 15, wherein if the UC is a personal UC, the server will not perform the programming instructions for notifying the second CD, since the personal UC does not involve the second CD.

17. The non-transitory computer-readable medium of claim 12, wherein the step of programming instructions implemented to notify, by the remote server, the second CD about the UC received by the first CD only after at least one other CD has received the same UC and reported such to the remote server.

18. The non-transitory computer-readable medium of claim 17, wherein during a period of time when the other CD has not yet received the same UC and reported such to the remote server, the first CD will still have the UC blocked.
